(19) United States
(12) Patent Application Publication
(10) Pub. No.: US 2015/0258763 A1
(43) Pub. Date: Sep. 17, 2015

(54) COMPONENTS MADE FROM PANELS AND METHODS OF PRODUCING THE SAME

(71) Applicant: Gulfstream Aerospace Corporation, Savannah, GA (US)

(72) Inventors: Susan S. Daggett, Savannah, GA (US); Charles Aitken, Savannah, GA (US)

(73) Assignee: Gulfstream Aerospace Corporation, Savannah, GA (US)

(21) Appl. No.: 14/204,782

(22) Filed: Mar. 11, 2014

(51) Int. Cl. B32B 37/18; B32B 7/12; B32B 5/18

(52) U.S. Cl. CPC B32B 37/185; B32B 5/18; B32B 7/12; B32B 2266/0221; B32B 2266/0264; B32B 2266/0271; B32B 2607/00; B32B 2305/02; B32B 2305/72

(57) ABSTRACT

Methods for producing panels and components made from panels are provided. A method of producing a panel includes positioning an expandable film between a first and second layer, where the first and second layer include a fiber and a resin. The expandable film is expanded such that a distance between the first and second layers increases as the expandable film expands. Expansion of the expandable film is terminated when a panel thickness is within 1% of a panel thickness specification, and a polymer in the expandable film is crosslinked while the panel thickness is within 1% of the panel thickness specification.

### FIELD OF THE INVENTION

The present disclosure generally relates to methods for producing panels with consistent thicknesses, and more particularly relates to methods for producing panels with consistent thicknesses using an expandable layer of varying thickness, and components made from such panels.

### BACKGROUND

Composite materials made from fibers and resin are used in a wide variety of components. Such composite materials have many useful properties, such as light weight, strength, and ease of manufacture. The resin is typically embedded in a sheet of the fiber and then cured, where the resin cross-links and becomes rigid. The fibers embedded in the cross-linked resin provide additional strength and can serve to secure the resin in a desired shape during lay-up, or prior to curing. Different sheets of fiber can be laid together to make several plys of the final composite, and the different sheets can be cured simultaneously or sequentially. Many different components are made from composite materials, including but not limited to aircraft components, sporting goods, boats, and protective equipment.

In many cases, different panels of composite materials are separately produced and then assembled into a final component. Each panel will typically have several plys of fiber and resin, and the thickness of each ply can vary. As the layers or plys are laid together, the final thickness of individual panels can vary due to varying thickness of the individual plys. This variation in panel thickness, sometimes referred to as cured ply thickness variation or CPT variation, can produce difficulties when different panels are assembled into a final component. The CPT variation may exceed design parameters or specifications for the panels. In such a case, additional manufacturing measures are taken to accommodate for panels with different thicknesses. For example, shims may be used to supplement a panel that is too thin, or a panel that is too thick may be cut down to size. The additional manufacturing measures used for CPT variation increases the time and cost of production for assembled components.

Accordingly, it is desirable to develop methods for producing panels with consistent thicknesses, and components made from panels having consistent thicknesses. In addition, it is desirable to develop methods for producing panels with a layer having an adjustable thickness that provides a consistent thickness from one panel to the next, and components made from such panels. Furthermore, other desirable features and characteristics of the present embodiment will become apparent from the subsequent detailed description and the appended claims, taken in conjunction with the accompanying drawings and this background.

### SUMMARY OF THE INVENTION

Methods for producing panels and components made from panels are provided. In an exemplary embodiment, a method of producing a panel includes positioning an expandable film between a first and second layer, where the first and second layers include a fiber and a resin. The expandable film is expanded such that a distance between the first and second layers increases as the expandable film expands. Expansion of the expandable film is terminated when a panel thickness is within 1% of a panel thickness specification, and a polymer in the expandable film is crosslinked while the panel thickness is within 1% of the panel thickness specification.

In accordance with another exemplary embodiment, a method of producing a panel is provided. A first layer and second layer are placed in a frame, where the first and second layers include a fiber and a resin. An expandable film is placed between the first and second layers in the frame. The expandable film is expanded such that the first layer moves toward a first frame plant, and a polymer in the expandable film is crosslinked.

In accordance with a further exemplary embodiment, a component is provided. The component includes a left and a right panel, where the left panel has a left panel first layer, a left panel second layer, and a left panel expandable film, and right panel has a right panel first layer, a right panel second layer, and a right panel expandable film. The left panel has a left panel thickness, the right panel has a right panel thickness, and the left and right panel thicknesses are about 1% or less of each other. A left panel expandable film thickness is about 2% or more different than a right panel expandable film thickness.

### BRIEF DESCRIPTION OF THE DRAWINGS

The present embodiment will hereinafter be described in conjunction with the following drawing figures, wherein like numerals denote like elements, and wherein:

FIG. 1 is an exploded perspective view of a frame in an exemplary embodiment;

FIG. 2 is an exploded cross sectional view of a panel within a frame in another exemplary embodiment;

FIG. 3 is a cross sectional view of an exemplary embodiment of the panel within the frame prior to expansion of an expandable film;

FIG. 4 is a cross sectional view of an exemplary embodiment of the panel within the frame after expansion of the expandable film;

FIG. 5 is a cross sectional view of a different embodiment of the panel within the frame after expansion of the expandable film; and

FIG. 6 is a cross sectional view of a portion of a component including a left panel and a right panel, in an exemplary embodiment.

### DETAILED DESCRIPTION

The following detailed description is merely exemplary in nature and is not intended to limit the application and uses of the embodiment described. Furthermore, there is no intention to be bound by any theory presented in the preceding background or the following detailed description.

The various embodiments described herein relate to methods for producing composite panels having a consistent thickness along the length and width of the panel, and a consistent thickness from one panel to the next. The panel is produced with an expandable film positioned between a first layer and a second layer of fiber and resin. The expandable film, the first layer, and the second layer are assembled within a frame, where a frame thickness is set at a panel thickness specification. The expandable film expands as it is cured until the panel fills the frame, so the panel thickness is substantially the same as the frame thickness even when the first and/or second layers of fiber and resin have variable thicknesses. Pressure builds once the expandable film expands to the point where the panel fills the frame, and the increased pressure prevents the expandable film from expanding beyond the point where the panel fills the frame. Different panels can then be assembled into a component, where the different panels have consisting panel thicknesses even though the individual layers of the different panels have different thicknesses.

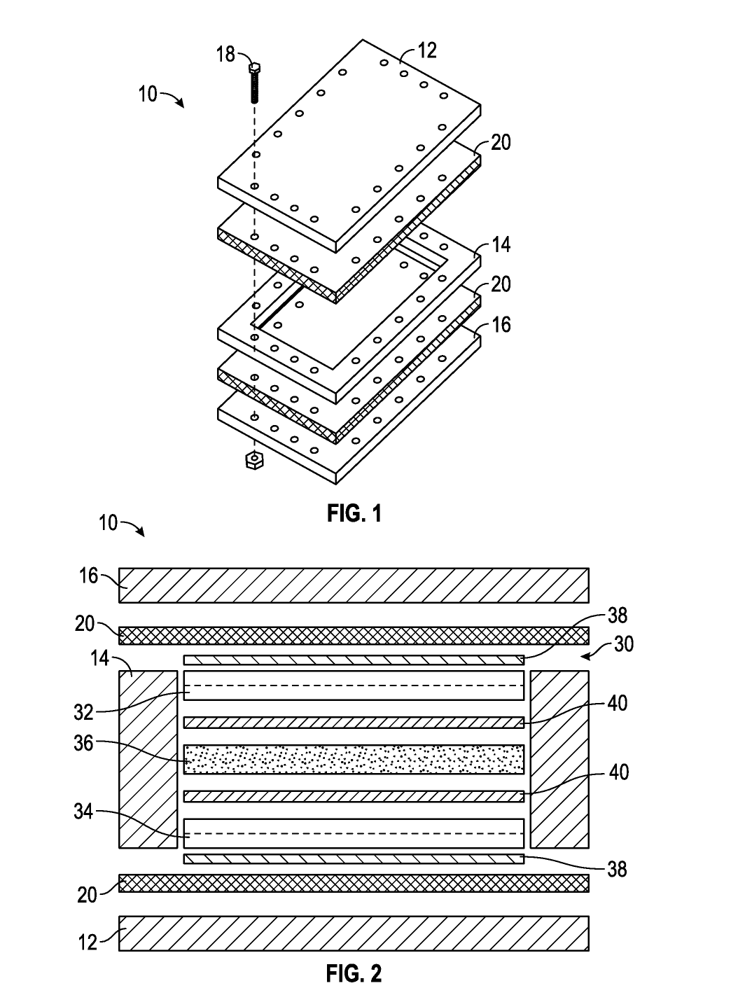

Reference is made to the exemplary embodiment illustrated in FIG. 1. A frame 10 is used to contain the panel during lay-up and curing. In the illustrated embodiment, the frame 10 includes a first plate 12, a border plate 14, and a second plate 16. A plurality of fasteners 18 connect the frame 10 together and secure the first and second plate 12, 16 at a fixed distance from each other. The fixed distance is determined, at least in part, by the thickness of the border plate 14. The fastener 18 can be a nut and bolt, as illustrated, but in other embodiments the fastener could be a clamp, a press, a vacuum and/or pressure system, or a wide variety of other fasteners 18. The frame 10 provides a riged shape for the panel, described below, and is constructed of a riged material capable of withstanding the pressure produced by an expanding film material, also described below. In some embodiments, the first and second plates 12, 16 and the border plate 14 are metallic, but in other embodiments they are composite materials, polymers, other materials, or combinations thereof with sufficient strength and rigidity to contain the expanding film. The frame 10 may be flat with a consistent thickness over the entire frame 10, as illustrated in FIG. 1, but in other embodiments the frame 10 is curved, bent, angled, includes areas with varying thickness, or has other shapes as desired for the panel to be produced. As such, panels of almost any shape can be formed within the frame 10.

In some embodiments, a vent layer 20 is added when the frame 10 is assembled, but the vent layer 20 is not a part of the frame 10 itself. The vent layer 20 is a material that allows gases or vapors to pass through it. Some resins generate vapors when curing, and venting of these vapors prevents or reduces gas bubbles that can distort the panel and increase the pressure within the frame 10. In some embodiments, the vent layer 20 is a fabric or woven material, such as a layer of fiberglass that may be coated with polytetrafluoroethylene. A vent layer 20 may be positioned adjacent to the first plate 12 and/or second plate 16, so vapors can be vented from one or both sides of the frame 10. In some embodiments, the vent layer 20 extends between the first and/or second plate 12, 16 and the border plate 14, so vapors can pass between the first and/or second plate 12, 16 and the border plate 14 and thereby escape from within the frame 10. In other embodiments, the vent layer 20 may contain vapors as they are generated, or may have limited vent locations to allow vapors to escape from within the frame 10. The fasteners 18 penetrate the vent layer(s) 20 when the frame 10 is assembled in some embodiments.

Referring to FIG. 2, a panel 30 is positioned within the frame 10. The panel 30 includes a first layer 32, a second layer 34, and an expandable film 36 positioned between the first and second layers 32, 34. The panel 30 may include other components, such as a third layer (not illustrated), a second expandable film (not illustrated), one or more adhesive layers 40, hardware (not illustrated), or a wide variety of other components. The first layer 32 and the second layer 34 are composite materials including a fiber and a resin. For example, the fiber may be fiberglass, carbon fiber, aramid, other polymeric fibers, natural fibers, or other fibrous materials. In many embodiments, the resin is a crosslinkable polymer, and may be an epoxy resin, a vinylester resin, a polyester resin, or other polymeric resins. In some embodiments, the first layer 32 and/or the second layer 34 are obtained with resin pre-impregnated in the fiber, where the resin has not cross-linked (uncured resin). Sheets of pre-impregnated fibers are commercially available products frequently referred to as a prepreg. In other embodiments, the fiber is laid in the frame 10, and the resin is saturated into the fiber in an uncured liquid state. In yet another embodiment, the first and/or second layers 32, 34 are fiber and resin where the resin has cured, so the first and/or second layers 32, 34 are stiff and maintain their shape. The first and/or second layers 32, 34 may include a plurality of layers of resin saturated fiber cloth, or plys, and the fiber and/or resin in one ply may be the same or different than the fiber and/or resin in another ply. As such, the resin(s) and fibers in the first layer 32 may be the same or different than the resin(s) and fibers in the second layer 34.

The expandable film 36 includes a crosslinkable polymeric compound, including but not limited to an epoxy, polyester, or vinylester resin, and also includes an expanding component. The expanding component may be a small sphere containing a volatile compound (such as hexane), where the volatile compound evaporates or otherwise expands upon heating to create vapor “bubbles” in the expandable film 36. In other embodiments, the expandable film 36 includes components that react and produce a gas, where the rate of reaction is very low until the expandable film is sufficiently heated. The expandable film 36 may be a syntactic foam in some embodiments, where the expandable film 36 includes a filler such as fibers or microspheres. Certain embodiments of an expandable film 36 are commercially available, such as the product sold under the trademark AMLITE LT64, available from TenCate Advanced Composites, 18410 Butterfield Blvd, Morgan Hill, Calif. 95037 USA, or the product sold under the trademark SYNSPAND 9899, available from Henkel Corporation Aerospace, 2850 Willow Pass Road, Bay Point, Calif. 94565 USA.

The curing process for the expandable film 36 includes two different stages; an expansion stage where the expandable film 36 expands to fill void space, and a setting stage where the polymers in the expandable film 36 crosslink to form a riged, stiff shape. Once the polymers complete the crosslinking process, the expandable film 36 is no longer able to expand and it maintains its size and shape. However, some polymers may crosslink during the expansion stage, but the degree of crosslinking during the expansion stage is not sufficient to prevent expansion. During the expansion stage, the expandable film 36 generates pressure as it expands. If the expandable film 36 is contained with sufficient counter-pressure, the expansion will stop. The amount of pressure generated may vary with the degree of expansion, where more pressure is generated when the expandable film 36 has expanded relatively little, such as about 20% or less of its total possible expansion, and less pressure is generated when the expandable film 36 has expanded significantly, such as about 80% or more of its total possible expansion.

A release film 38 may be included in the frame 10 to facilitate separation of the panel 30 from the frame 10. The release film 38 may be a layer of polytetrafluoroethylene, a liquid oil layer, or other materials that are low-stick. The first layer 32 is positioned facing the first plate 12, and the second layer 34 is positioned facing the second plate 16, where the reference to first and second does not denote an order or orientation but is merely used to differentiate the parts. The release film 38 may be positioned in contact with the first layer 32 and between the first layer 32 and the first plate 12, such as between the first layer 32 and the vent layer 20 if present. Another release film 38 may be similarly positioned for the second layer 34. Although not illustrated in FIG. 2, it will be appreciated that a release film 38 may also be positioned between the ends of the panel 30 and the border plate 14 in some embodiments.

An adhesive layer 40 may be positioned between the expandable film 36 and the first and/or second layers 32, 34. The adhesive layer 40, if present, aids in adhesion of the expandable film 36 with the first and/or second layers 32, 34. Strong adhesion between the various layers of the panel 30 increases the strength of the panel 30 as a whole. In an exemplary embodiment, the adhesive is epoxy or a modified epoxy, which may or may not include moisture resistant carriers such as polyester, but other adhesives can also be used. Adhesives are commercially available, such as the product sold under the trademark FM300K, available from Cytec Engineered Materials, Tempe, Ariz., USA.

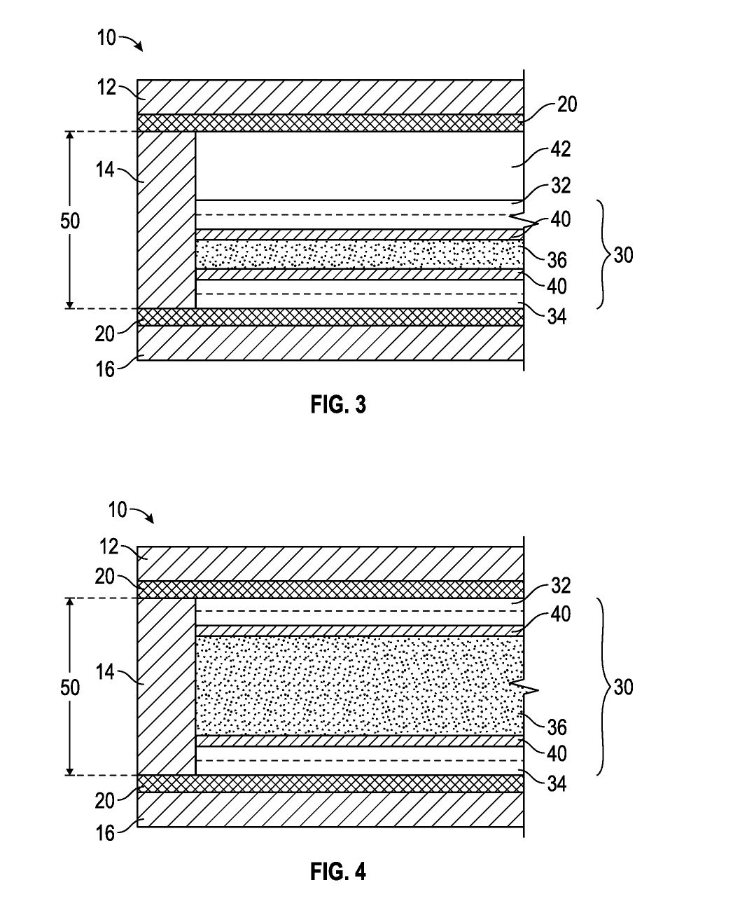

Referring to FIG. 3, with continuing reference to FIG. 2, the panel 30 is assembled in the frame 10. The second layer 34 is positioned facing the second plate 16 of the frame 10, the first layer 32 is positioned facing the first plate 12, and the expandable film 36 is positioned between the first and second layers 32, 34. In some embodiments, the expandable film forms an uninterrupted expandable film layer between the first and second layers 32, 34, so there is no honeycomb or other structure between the first and second layers 32, 34 other than the expandable film 36. One or more vent layers 20 and adhesive layers 40 may be optionally included as well, as described above. The frame 10 is assembled with the components of the panel 30 inside it. The second layer 34 is positioned in contact with the second plate 16, or in contact with another material positioned between the second layer 34 and the second plate 16 (such as the vent layer 20 and/or release film 38.) A gap 42 is formed between the first layer 32 and the first plate 12. There may be a vent layer 20, a release film 38, or other layers between the first layer 32 and the first plate 12, but there is also the gap 42 between the first layer 32 and first plate 12 where the gap is either a gas, such as air, or a vacuum. The expandable film 36 is not cured at this point.

The expandable film 36 is cured after the panel 30 is assembled in the frame 10, as illustrated in FIG. 4 with continuing reference to FIGS. 2 and 3. The expandable film 36 expands as it is cured, so the first layer 32 moves towards the first plate 12 until the gap 42 is closed and the first layer 32 makes contact with the first plate 12 or a material between the first layer 32 and the first plate 12. As such, a distance between the first and second layers 32, 34 increases as the expandable film 36 expands, and the thickness of the panel 30 increases. The expandable film 36 creates pressure after the gap 42 is closed, and the frame 10 is designed to withstand the pressure and maintain the panel 30 within the confines of the frame 10. An interframe thickness 50, indicated by the double headed arrows, is the distance between the first and second plates 12, 16, or between materials contacting the first and/or second plates 12, 16, other than the panel 30, and is the distance that the panel 30 expands to within the frame 10. The interframe thickness 50 is a panel thickness specification, and the panel 30 conforms to within about 1% of the panel thickness specification because the panel 30 expands to fill the interframe thickness 50. The expandable film 36 expands until the panel fills the interframe thickness 50, and then the expansion is terminated because there is no more room within the frame 10 for further expansion. After the panel 30 fills the interframe thickness 50 and the expansion is terminated, the expandable film 36 continues curing and hardens as its polymers crosslink. Once the expandable film 36 is fully cured and hard, such that no more expansion is possible, it can be removed from the frame 10.

In some embodiments, the first and/or second layer 32, 34 are cured simultaneously with the expandable film 36. The curing process is initiated by elevating the temperature of the panel assembly to above a cure initiation temperature in some embodiments, or the cure may be initiated by other processes such as combining a catalyst with other resin components as the panel 30 is assembled in the frame 10. The cure initiation temperature for the expandable film 36 may be similar to a cure initiation temperature for the resin in the first and/or second layer 32, 34 in some embodiments, which facilitates a simultaneous cure. In an exemplary embodiment, the cure initiation temperature is above normal storage temperatures, such as above about 50 degrees centigrade (° C.), so the various components do not begin to cure while in storage before use. In other embodiments, components may be refrigerated or stored at controlled temperatures to minimize premature curing, or curing before use. Several different processes can be combined in varying manners for the cure. For example, curing of the first and/or second layers 32, 34 may be initiated by mixing a catalyst with a resin, while curing of the expandable film 36 may be initiated by heat. The method of cure initiation for each component of the panel 30 that includes a curable resin can be selected as desired, and the time and sequence of the cures for the various layers can also be adjusted. Simultaneously curing the first and/or second layers 32, 34 with the expandable film 36 may improve the bond strength between the various layers in some embodiments.

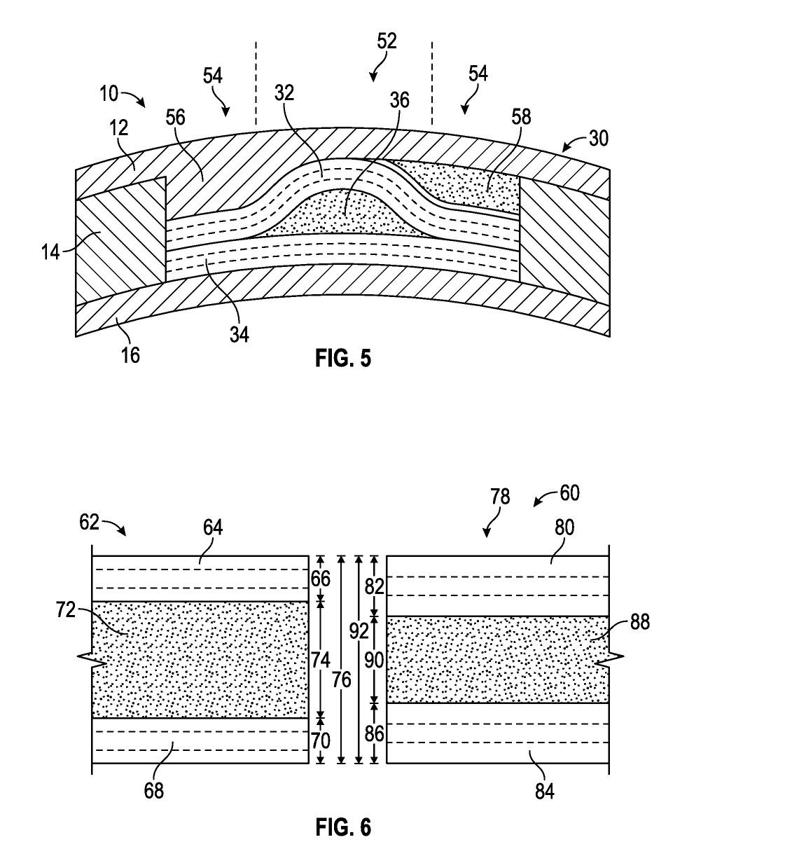

Reference is now made to FIG. 5, with continuing reference to FIGS. 2-4. The interframe thickness 50 may or may not be the same for the entire length and width of the panel 30, so the panel thickness specification may be different for various locations on the panel 30. The frame 10 and panel 30 may have curves or bends as well in some embodiments, as mentioned above.

In an exemplary embodiment, the panel 30 may have one or more expansion portions 52 and one or more field portions 54. The expandable film 36 is positioned between the first and second layers 32, 34 in an expansion portion 52, and the expandable film 36 is not positioned between the first and second layers 32, 34 in a field portion 54 of the panel 30. The first and second layers 32, 34 may be placed in contact with each other in the field portion(s) 54 in an exemplary embodiment, but in another embodiment an adhesive layer (not illustrated in FIG. 5) or a material other than the expandable film 36 is positioned between the first and second layers 32, 34 in the field portion(s) 54. In some embodiments, the expandable film 36 forms an uninterrupted expandable film layer between the first and second layers 32, 34 in the expansion portion, as described above.

The expandable film 36 can expand to increase the thickness of the panel 30, so it expands generally along a line perpendicular to the first and second plates 12, 16, but the expandable film 36 can also expand along the length and/or width of the panel 30. For example, if the gap 42 extends over a field portion 54 adjacent to an expansion portion 52, the pressure produced as the expandable film 36 expands and pushes the first layer 32 against the first plate 12 can also produce a pressure to separate the first and second layers 32, 34 in the field portion 54. Pressure will urge the expandable film 36 into any space created between the first and second layers 32, 34 adjacent to an expansion portion 52. This migration of the expandable film 36 may be prevented by preventing the first and second layers 32, 34 from separating in the field portion. In many embodiments, there is not honeycomb or similar structure in the expansion portion 52 to limit the lateral expansion of the expandable film 36.

Various actions can be taken to prevent the lateral migration of the expandable film 36. In one embodiment, a mound 56 is formed on the first and/or second plate 12, 16 in the field portion 54 to reduce the interframe thickness 50 such that there is no gap 42, or a very small gap 42, over the first layer in the field portion 54. As such, the mound 56 prevents the first and second layers 32, 34 from separating, and serves to prevent the migration of the expandable film 36 from the expansion portion 52 into the field portion 54. In another embodiment, an external expandable film 58 is placed between the first layer 32 and the first plate 12, but not between the first layer 32 and the second layer 34, so the external expandable film 58 presses the first and second layers 32, 34 together as it expands. A release layer (not illustrated in FIG. 5) may be positioned between external expandable film 58 and the panel 30 to aid in separation when removed from the frame. In a similar manner, the external expandable film 58 could be placed between the second layer 34 and the second plate 16 instead of or as well as between the first layer 32 and the first plate 12. As such, the external expandable film 58 is placed between the panel 30 and the frame 10 in the field portion 54 in some embodiments.

A component 60 is assembled from a plurality of panels 30 in an exemplary embodiment illustrated in FIG. 6. The panels 30 include a left panel 62 and a right panel 78, where the terms left and right are used to distinguish the different panels but are not intended to indicate a relative position of the panels 30. The left panel 62 has a left panel first layer 64 with a left panel first layer thickness 66, a left panel second layer 68 with a left panel second layer thickness 70, and left panel expandable film 72 with a left panel expandable film thickness 74, where the thicknesses are indicated by the numbers associated with the double headed arrows. The left panel first layer 64 and the left panel second layer 68 are on opposite sides of the left panel expandable film 72, as described above. The left panel 62 also has a left panel thickness 76 extending from the top to the bottom of the left panel 62. The right panel 78 has a right panel first layer 80 with a right panel first layer thickness 82, a right panel second layer 84 with a right panel second layer thickness 86, a right panel expandable film 88 and a right panel expandable film thickness 90, and a right panel thickness 92 for the entire right panel 78, where the thicknesses are again indicated by the numbers associated with the double headed arrows. Due to standard variations, the first and second layers of the left and right panels 62, 78 have different thicknesses. However, the overall left panel thickness 76 is within about 1% of the overall right panel thickness 92. The overall thickness of the left and right panels 62, 78 are within about 1% of each other because the respective expandable films filled the associated frames to produce an overall thickness within about 1% of the panel thickness specification. In an exemplary embodiment, the left panel expandable film thickness 74 is about 2% or more different than the right panel expandable film thickness 90, and this difference in expandable film thickness adjusts and compensates for the varying thickness of the other component parts of the left and right panels 62, 76. Thus, the component 60 has a smooth joint or union where the left and right panels 62, 76 are joined.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the application in any way. Rather, the foregoing detailed description will provide those skilled in the art with a convenient road map for implementing one or more embodiments, it being understood that various changes may be made in the function and arrangement of elements described in an exemplary embodiment without departing from the scope, as set forth in the appended claims.

1. A method of producing a panel comprising:
positioning an expandable film between a first layer and a second layer of the panel, wherein the first layer and the second layer comprise a fiber and a resin;
expanding the expandable film such that a distance between the first layer and the second layer increases as the expandable film expands;
terminating expansion of the expandable film when a panel thickness is within 1% of a panel thickness specification; and
crosslinking a polymer in the expandable film while the panel thickness is within 1% of the panel thickness specification.

2. The method of claim 1 wherein terminating expansion of the expandable film comprises positioning the expandable film, the first layer, and the second layer within a frame.

3. The method of claim 1 further comprising:
curing the resin of the first layer and the second layer while curing the expandable film.

4. The method of claim 3 further comprising:
venting gases from the first layer and the second layer while curing the resin of the first layer and the second layer.

5. The method of claim 1 wherein positioning the expandable film between the first layer and the second layer comprises positioning the expandable film between the first layer and the second layer at an expansion portion of the panel.

6. The method of claim 5 further comprising:
positioning the first layer in contact with the second layer at a field portion of the panel.

7. The method of claim 5 further comprising:
preventing migration of the expandable film from the expansion portion of the panel into a field portion of the panel.

8. The method of claim 7 wherein preventing migration of the expandable film further comprises placing the expandable film between a frame and the panel in the field portion of the panel.

9. The method of claim 1 further comprising:
positioning an adhesive between the expandable film and the first layer.

10. The method of claim 1 wherein positioning the expandable film between the first layer and the second layer comprises positioning the expandable film between the first layer and the second layer at an expansion portion of the panel wherein the expandable film forms an uninterrupted expandable film layer between the first layer and the second layer in the expansion portion of the panel.

11. The method of claim 1 wherein positioning the expandable film between the first layer and the second layer comprises positioning the expandable film between the first layer and the second layer wherein the expandable film comprises the fiber.

12. A method of producing a panel comprising:
placing a first layer in a frame, wherein the first layer comprises a fiber and a resin;
placing a second layer in the frame, wherein the second layer comprises the fiber and the resin;
placing an expandable film between the first layer and the second layer in the frame;
expanding the expandable film such that the first layer moves toward a first plate of the frame; and
crosslinking a polymer in the expandable film.

13. The method of claim 12 further comprising:
placing a vent layer between the first layer and the first plate.

14. The method of claim 13 wherein placing the expandable film between the first layer and the second layer comprises placing the expandable film between the first layer and the second layer wherein the expandable film comprises the fiber.

15. The method of claim 12 further comprising:
placing an adhesive between the expandable film and the second layer.

16. The method of claim 12 further comprising:
curing the first layer while crosslinking the polymer in the expandable film.

17. The method of claim 12 wherein placing the expandable film between the first layer and the second layer comprises placing the expandable film between the first layer and the second layer in an expansion portion of the panel.

18. The method of claim 17 further comprising:
contacting the first layer with the second layer within the frame in a field portion of the panel.

19. The method of claim 12 wherein placing the expandable film between the first layer and the second layer comprises placing the expandable film between the first layer and the second layer in an expansion portion of the panel, wherein the expandable film forms an uninterrupted expandable film layer between the first layer and the second layer in the expansion portion of the panel.

20. A component comprising:
a left panel and a right panel, wherein the left panel comprises a left panel first layer and a left panel second layer on opposite sides of a left panel expandable film, and wherein the right panel comprises a right panel first layer and a right panel second layer on opposite sides of a right panel expandable film;
wherein the left panel has a left panel thickness and the right panel has a right panel thickness, and the left panel thickness and the right panel thickness are about 1% or less of each other; and
wherein a left panel expandable film thickness and a right panel expandable film thickness are about 2% or more different than each other.
